(19) United States
(12) Patent Application Publication
(10) Pub. No.: US 2010/0287473 A1
(43) Pub. Date: Nov. 11, 2010

(54) VIDEO ANALYSIS TOOL SYSTEMS AND METHODS

(76) Inventors: Arthur Recesso, Watkinsville, GA (US); Michael Hannafin, Athens, GA (US); Vineet Khosla, San Jose, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/160,984

(22) PCT Filed: Jan. 17, 2007
(86) PCT No.: PCT/US07/01198

§ 371 Date: Jul. 21, 2010

Related U.S. Application Data
(60) Provisional application No. 60/759,306, filed on Jan. 17, 2006.

(51) Int. Cl. G06F 3/00; G06F 17/40

(52) U.S. Cl. 715/716

(57) ABSTRACT

Video analysis tool systems and methods that receive evidence of an event over a network and a user-selected segment of the evidence, and present a standards-based assessment option that a user can associate to the segment.

### CROSS-REFERENCE TO RELATED APPLICATION

This application claims priority to copending U.S. provisional application entitled, “Video Analysis Tools Systems and Methods,” having Ser. No. 60/759,306, filed Jan. 17, 2006, which is entirely incorporated herein by reference.

### STATEMENT REGARDING FEDERALLY SPONSORED RESEARCH OR DEVELOPMENT

This invention was made with government support under Grant No.: P342A030009 awarded by the U.S. Department of Education. The government has certain rights in the invention.

### TECHNICAL FIELD

The present disclosure is generally related to computer systems, and, more particularly, is related to systems and methods of assessment.

### BACKGROUND

Educational or professional development necessarily entails some degree of training, with a nearly infinite variety of approaches with effectiveness that may vary from student-to-student. For instance, a grammar school student learning arithmetic might find comprehension more favorable in a personalized, interactive setting, where the student can ask questions without fear of criticism from peers and receive step-by-step assistance in solving math problems. Other students may thrive on a less personalized approach, preferring (consciously or subconsciously) instead a more structured environment among peers that provides more competitive-drive motivation than a personalized approach. In either case, an instructor should recognize these differences through observation and employ methods that are best suited to address such differences. In a traditional setting, an instructor may be observed by a mentor who can assess the instructional methods used by the instructor and provide subjective feedback as to what approaches work best for the given environment. In assessing the instructor, the mentor is likely to draw on experience and/or perhaps knowledge gained from review of guidelines or principles set forth by an employer or by industry. In either case, the assessment varies based on the skill, observation acumen, and availability of the mentor, each of which can directly impact instructor performance and hence student comprehension.

### SUMMARY

Embodiments of the present disclosure provide video tool systems and methods. Briefly described, one embodiment of a method, among others, comprises receiving evidence of an event over a network, receiving an indication of a user-selected segment of the evidence, and presenting a standards-based assessment option that a user can associate to the segment.

An embodiment of the present disclosure can also be viewed as providing video tool systems for assessing evidence. One system embodiment, among others, comprises a processor configured with logic to receive evidence of an event and an indication of a user-selected segment of the evidence, and present a standards-based assessment option that a user can associate to the segment.

One system embodiment, among others, comprises means for receiving evidence of an event, means for receiving an indication of a user-selected segment of the evidence, and means for presenting a standards-based assessment option that a user can associate to the segment.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates an embodiment of a video analysis tool (VAT) system.

FIG. 2 is a block diagram of select components of an embodiment of a VAT server system shown in FIG. 1.

FIG. 3 is a screen diagram of an embodiment of a graphics user interface (GUI) employed by the VAT system of FIG. 1 from which various interfaces can be launched.

FIG. 4 is a screen diagram of an embodiment of a live event GUI launched from the GUI shown in FIG. 3, the live event GUI providing filenames of events scheduled to be presented in real-time.

FIG. 5 is a screen diagram of an embodiment of a view event GUI launched from the GUI shown in FIG. 4, the view event GUI providing an interface from which an event can be viewed in real-time and marked up during the viewing.

FIG. 6 is a screen diagram of an embodiment of a file list GUI launched from the GUI shown in FIG. 3, the file list GUI providing filenames of recorded events.

FIGS. 7A-7B are screen diagrams of embodiments of refine clips GUIs launched from the GUI shown in FIG. 6, the refine clips GUIs providing a user the ability to provide standards-based assessment of evidence.

FIG. 8 is a screen diagram of an embodiment of a view clips GUI launched from the GUI shown in FIG. 3, the view clips GUI providing an interface that summarizes which clips are coded and un-coded, and how the coded clips are coded.

FIG. 9 is a screen diagram of an embodiment of a view multiple clips GUI launched from the GUI shown in FIG. 3, the view multiple clips GUI providing an interface that enables a user to compare how a particular segment was coded by others.

FIG. 10 is a flow diagram that illustrates a VAT method embodiment.

### DETAILED DESCRIPTION

Various embodiments of video analysis tool (VAT) systems and methods (herein, collectively referred to also as VAT systems) are disclosed, which comprise a core technology for the capture and codification of evidence. In one embodiment, a VAT system comprises a Web-based program designed to capture and analyze evidence. That is, VAT software in the VAT system enables the uploading and analysis of video evidence (and data corresponding to other evidence) using pre-developed assessment instruments called lenses. One embodiment of the VAT software includes graphics user interface (GUI)/web-interface functionality that provides video capture and analysis tools for defining and reflecting on evidence. Evidence of performance or practice is recorded through video cameras (and/or other evidence capture devices) and stored in one or more storage device associated with a server device of the VAT system for review or analysis. Evidence (e.g., video data, audio data, biofeedback data, and/or other information) can be captured in two forms: live, real-time capture and post-event upload. In live capture, an evidence capture device such as an Internet protocol (IP) video camera is pre-installed in a remote location, passing video streams to the server device of the VAT system, which records the video streams, enabling a rater to observe practices unobtrusively with minimal disruption or interference. Post-event upload refers to archiving video files on the VAT system server device subsequent to recording a practice. VAT users can videotape an event in real-time, and subsequently digitize and upload the converted files to the server device. While perhaps increasing the time and effort required to gather evidence in some instances, post-event uploading provides additional backup in the event of network or data transfer failures.

Evidence assessment, such as via video analysis, enables users to conduct deep inquiries into key practices. Such users can view a video of specific events and segment the video into smaller sessions of specific interest keyed to defined areas, needs or priorities. Refined sessions, called VAT clips or segments, are especially useful in refining the scope of an inquiry, providing users the ability to observe and reflect without the ‘noise’ or ‘interference’ of extraneous events. For instance, once the evidence is received and stored, VAT software in the server system enables, through one or more GUIs (or, more generally, interfaces), individuals, multiple users, or even teams to access the evidence and associate metadata at varying levels of granularity with specific instances embedded within the evidence. That is, various embodiments of the VAT software enable users to segment, annotate, and associate pre-designed descriptive instruments (even measurement indicators) and/or ad-hoc commentary with that evidence in real-time or delayed time.

Certain embodiments of VAT systems provide direct evidence of the link between practices and target goals, and the means through which progress can be documented, analyzed and assessed. There exists a wide array of decision making and performance assessment methodologies that enable different stakeholders to systematically examine evidence of the relationship between practices and goals, such as attaining certification for surgical procedures or mastering jet landings on an aircraft carrier. The VAT systems described herein incorporate such methodologies to enable practitioners (e.g., pilot, instructor, team leader, etc.), support professionals (e.g., mentor or coach), and raters (e.g., leaders or supervisor) from multiple sectors to systematically capture and codify evidence. Although certain embodiments of VAT systems are described below in the context of capturing evidence in a classroom education setting, VAT systems can be applied to any sector (e.g., education, military, medicine, industry) where there is a need to collect, organize, and manage evidence capture and analysis.

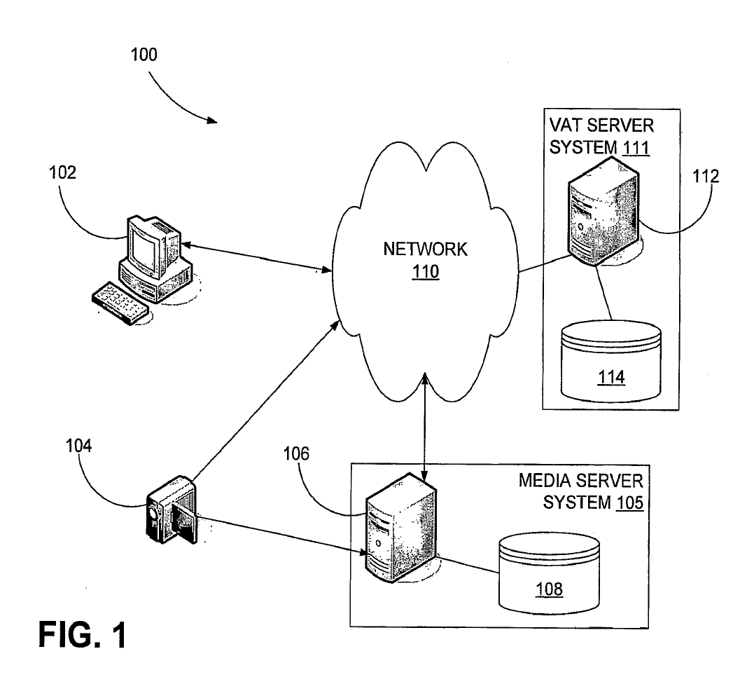

FIG. 1 is a schematic diagram that illustrates an embodiment of a VAT system 100. The VAT system 100 comprises a user computing device 102, an evidence capture device 104, a media server system 105 comprising a server device 106 and a storage device 108, and a VAT server system 111 comprising a server device 112 and a storage device 114. A network 110 provides a medium for communication among one or more of the above-described devices. The network 110 may comprise a local area network (LAN) or wide area network (WAN, such as the Internet), and may be further coupled to one or more other networks (e.g., LANs, wide area networks, regional area networks, etc.) and users. The user computing device 102 comprises a web browser that enables a user to access a web-site provided by the VAT server system 111. Access to the VAT server system 111 by the evidence capture device 104, user computing device 102, and/or media server system 105 can be accomplished through one or more of such well-known mechanisms as CGI (Common Gateway Interface), ASP (Application Service Provider) and Java, among others. The VAT system Web-based interfaces (GUIs) may be implemented using platform independent code (e.g., Java), though not limited to such platforms. In some embodiments, and as a non-limiting example, the VAT system Web-based interfaces may be accessed through Internet Explorer 6 and Windows Media Player 10 on a personal computer (PC) or other computing device. The combination of open source and industry standard technologies of the VAT system 100 makes the VAT tools accessible wherever broadband (DSL, Cable) Internet connections are available.

The server device 106 comprises a web-server that, in one embodiment, provides Java server pages. The storage devices 114 and 108, though shown separate from their respective server devices 112 and 106, may be integrated within the respective server device in some embodiments. One skilled in the art can understand that the various storage devices 108 and 114 can be configured with data structures such as databases (e.g., ORACLE), and may include digital video disc (DVD) or other storage medium. The evidence capture device 104 is configured in one embodiment as an IP-based camera, including a file transport protocol (FTP) and/or hypertext transport protocol (HTTP) server. The media server system 105 also is configured, in one embodiment, as an FTP and/or HTTP server.

The manner of communication throughout the VAT system 100 depends on the particular installation and capabilities of the system 100. For instance, the evidence capture device 104 may be configured to send live video to the VAT server system 111 via HTTP, or upload live video to media storage system 105 via FTP. The VAT server system 111 may be configured to upload a media file from the media server system 105 via FTP, or request a file via HTTP.

Each of the aforementioned devices may be located in separate locales, or in some implementations, one or more of such devices may reside in the same location. For instance, the media server system 105 may reside in the same general location (e.g., a classroom in a middle school) as the evidence capture device 104. Further, the VAT system 100 can include a plurality of networks. For instance, the VAT server system 111 may receive evidence from a plurality of locations (e.g., one or more classroom settings in the same or different schools). Further, in some implementations, such as a corporate setting, the VAT server system 100 may be located at the corporate facility, and one or more offices or areas of the corporation may provide residence for one or more evidence capture devices 104 that communicate over one or more local area networks (LAN) provided within the corporate facility.

Further, one skilled in the art can understand that communication among the various components of the VAT system 100 can be provided using one or more of a plurality of transmission mediums (e.g., Ethernet, T1, hybrid fiber/coax, etc.) and protocols (e.g., via HTTP and/or FTP, etc.).

Learning objects are generated via live capture or real-time events, such as in remote locations, and/or uploading pre-recorded content. Considering one exemplary live capture operation, through a VAT interface (e.g., GUI) generated and displayed by VAT software residing in the VAT server system 111, the user can schedule the evidence capture device 104 that has been pre-installed to capture classroom events on demand or at specific intervals (e.g., 5^{th} period every day), making pervasive video capture of learning environments possible. One or more users in remote locations at computing devices, such as computing device 102 (e.g., using broadband Internet access and a Web browser) can observe the classroom events in real time as they unfold. Using a VAT interface and, for instance, an Internet protocol (IP) video camera (as an embodiment of the evidence capture device 104) connected to a classroom Ethernet port, users are able to simultaneously stream live video to their own local computing device 102 and to campus mass storage facilities (e.g., media server system 105), providing both immediate local access as well as redundancy in the event of malfunctions at either location. In one embodiment, the evidence capture device 104 has a built-in FTP (file transfer protocol) and Web server, enabling remote configuration and control of the video content at all times.

Live capture may overcome many logistical and technical challenges to capturing teaching events from the classroom. For instance, there is no longer a need to be physically present in the environment to capture practices, as the camera can be remotely configured and controlled during the live event. Previously formidable barriers to pervasive capture, such as availability of hard-disk space, have been addressed via access to inexpensive storage on computers. Using the Web-based VAT interfaces of the VAT system 100, both novice and expert users can capture content, generate learning objects, create resources on demand, and make such resources accessible virtually instantaneously.

During live capture, the file transfer may include both images of the environment (content) and packets (data) containing a wide array of metadata, including time, date, frame rate, quality settings, among other information. All or substantially all data is “read” by the server device 112 and stored in corresponding database tables of the storage device 114 as it streams through the VAT interface. Start and stop time buttons (explained below), for example, enable a user to segment (chunk) video into clips precisely encapsulating an event. The real-time processing of data through the VAT interfaces enables a user to initially chunk large volumes of content into manageable segments based on the frames planned for detailed analysis.

As another exemplary process, consider evidence capture using pre-recorded video. Pre-recorded video from a variety of media can be accommodated by the VAT system 100. Recently, powerful devices (e.g., Webcams, CCD DV video cameras, even VHS) have emerged that support a wide variety of formats (e.g., MPEG2, MPEG4, AVI, etc.). Using the memory media (e.g., tape, Microdrive, SD RAM, etc.) to which the events have been captured, the VAT system 100 processes data using a device that reads the media for video files. Video files on the media may be translated into a common digital format (MS Win Media 10) using open source codecs (code and decode video for use on multiple computers) to compress the video. This process both reduces storage requirements and ensures broader file access. In some embodiments, immediately following this encoding process, files are transferred to mass storage (e.g., storage device 114) and referenced in the database or data structure incorporated therein for immediate access and use. In some implementations, the entire translation and upload process can be accomplished in less than one hour per hour of video.

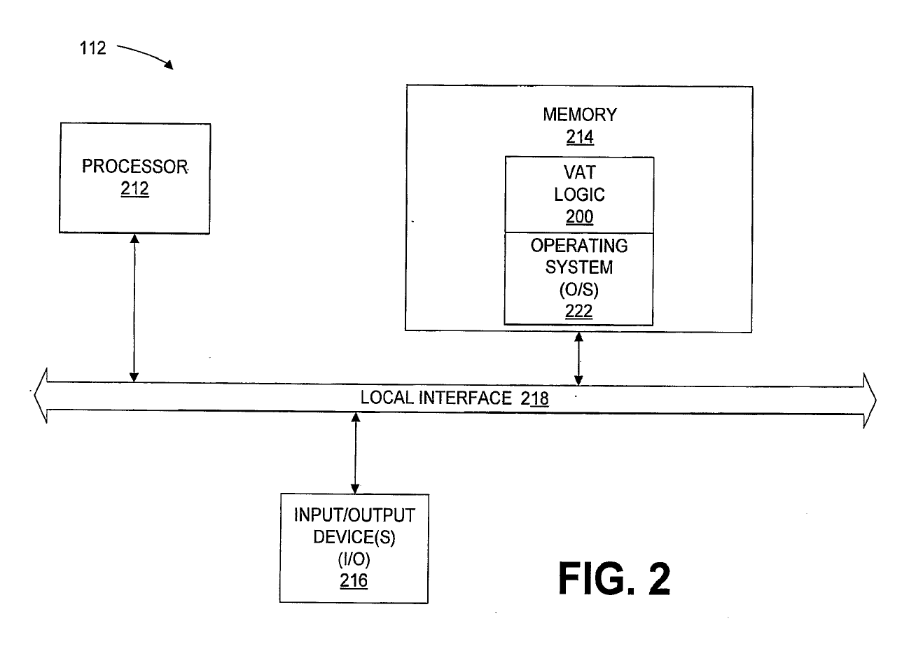

FIG. 2 is a block diagram showing an embodiment of the VAT server system 111 shown in FIG. 1. VAT software for implementing VAT functionality (e.g., GUI/web-site generation and display, real-time tagging of video segments, tagging of video segments during review of pre-recorded video, annotations based on standards or personal choice, etc.) is denoted by reference numeral 200. Note that one having ordinary skill in the art can understand, in the context of this disclosure, that in some embodiments, one or more functionality of the VAT software can be accomplished through hardware or a combination of hardware and software (including in some embodiments, firmware). Further, in some embodiments, one or more of the VAT functionality may be performed using artificial intelligence to support or provide assessment of evidence. Generally, in terms of hardware architecture, the VAT server system 111 includes a processor 212, memory 214, and one or more input and/or output (I/O) devices 216 (or peripherals) that are communicatively coupled via a local interface 218. The local interface 218 may be, for example, one or more buses or other wired or wireless connections. The local interface 218 may have additional elements such as controllers, buffers (caches), drivers, repeaters, and receivers, to enable communication. Further, the local interface 218 may include address, control, and/or data connections that enable appropriate communication among the aforementioned components.

The processor 212 is a hardware device for executing software, particularly that which is stored in memory 214. The processor 212 may be any custom made or commercially available processor, a central processing unit (CPU), an auxiliary processor among several processors associated with the VAT server system 111, a semiconductor-based microprocessor (in the form of a microchip or chip set), a macroprocessor, or generally any device for executing software instructions.

The memory 214 may include any one or combination of volatile memory elements (e.g., random access memory (RAM)) and nonvolatile memory elements (e.g., ROM, hard drive, etc.). Moreover, the memory 214 may incorporate electronic, magnetic, optical, and/or other types of storage media. Note that the memory 214 may have a distributed architecture in which where various components are situated remotely from one another but may be accessed by the processor 212.

The software in memory 214 may include one or more separate programs, each of which comprises an ordered listing of executable instructions for implementing logical functions. In the example of FIG. 2, the software in the memory 214 includes the VAT software 200 according to an embodiment and a suitable operating system (O/S) 222. The operating system 222 essentially controls the execution of other computer programs, such as the VAT software 200, and provides scheduling, input-output control, file and data management, memory management, and communication control and related services.

The VAT software 200 is a source program, executable program (object code), script, or any other entity comprising a set of instructions to be performed. The VAT software 200 can be implemented, in one embodiment, as a distributed network of modules, where one or more of the modules can be accessed by one or more applications or programs or components thereof. In some embodiments, the VAT software 200 can be implemented as a single module with all of the functionality of the aforementioned modules. When the VAT software 200 is a source program, then the program is translated via a compiler, assembler, interpreter, or the like, which may or may not be included within the memory 214, so as to operate properly in connection with the O/S 222. Furthermore, the VAT software 200 can be written with (a) an object oriented programming language, which has classes of data and methods, or (b) a procedure programming language, which has routines, subroutines, and/or functions, for example but not limited to, C, C++, Pascal, Basic, Fortran, Cobol, Peri, Java, and Ada.

The I/O devices 216 may include input devices such as, for example, a keyboard, mouse, scanner, microphone, multimedia device, database, application client, and/or the media storage device, among others. Furthermore, the I/O devices 216 may also include output devices such as, for example, a printer, display, etc. Finally, the I/O devices 216 may further include devices that communicate both inputs and outputs such as, for instance, a modulator/demodulator (modem for accessing another device, system, or network), a radio frequency (RF) or other transceiver, a telephonic interface, a bridge, a router, etc.

In one embodiment, the I/O devices 216 include storage device 114, although in some embodiments, the I/O device 216 may provide an interface to the storage device 114. Initial VAT metadata descriptions are generated using database descriptors. Metadata schemes can also be created or adopted (e.g., international standard such as Dublin Core or SCORM). Using a standard scheme ensures that learning objects (e.g., instructional plan databank, a digital library of learning activities, resources for content knowledge) can be shared through a common interface.

VAT metadata tags are automatically generated for application functions (e.g., click on start time, as described further below), and associated with the source video during encoding or updating. Video content and metadata, stored in separate tables in some embodiments, are cross-referenced based on associations created by the user. Maintaining separate content and metadata tables enables multiple users to mark-up and share results without duplicating the original source video files. However, it is understood that a single table for both may be employed in some embodiments.

When the VAT server system 111 is in operation, the processor 212 is configured to execute software stored within the memory 214, to communicate data to and from the memory 214, and to generally control operations of the VAT server system 111 pursuant to the software. The VAT software 200 and the O/S 222, in whole or in part, but typically the latter, are read by the processor 212, perhaps buffered within the processor 212, and then executed.

When the VAT software 200 is implemented in software, as is shown in FIG. 2, it should be noted that the VAT software 200 can be stored on any computer-readable medium for use by or in connection with any computer-related system or method. In the context of this document, a computer-readable medium is an electronic, magnetic, optical, or other physical device or means that can contain or store a computer program for use by or in connection with a computer related system or method. The VAT software 200 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

The VAT software 200, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In addition, the scope of embodiments include embodying the functionality of the preferred embodiments in logic embodied in hardware or software-configured mediums. Hence, logic refers herein to a medium configured with hardware, software, or a combination of hardware and software for performing VAT functionality.

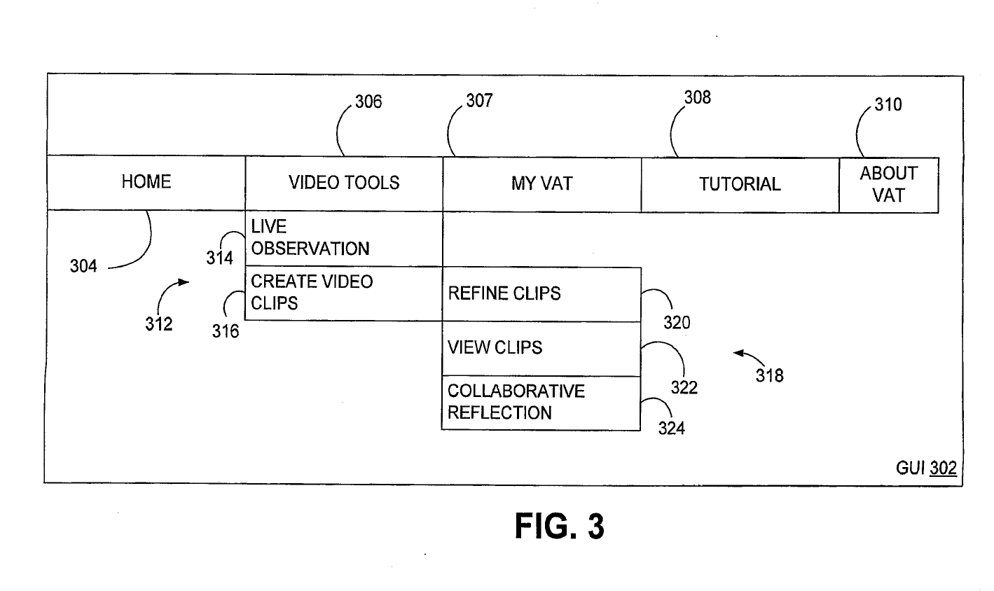

As explained above, the VAT system 100 provides for web-based interaction with one or more users. In FIGS. 3-9, various exemplary GUIs are illustrated that enable user interaction with the VAT system 100 to provide standards-based assessment of evidence. In general, the user may access captured evidence of practice from a standard computer using video tools or interfaces available through the VAT software 200, including the following tools: create video clips, refine clips, view my clips, and view multiple clips. Through “create video clips,” a coarse video segmenting of the overall video can take place, providing markers as reminders of where target practices might be examined more deeply. After initial live observation or during post-event review, the user applies a “refine clips” tool to make further passes at each segment to define specific, finer grained activities, such as when key events occurred. During refinement, the user defines clips where specific evidence is associated with criteria of interest, such as particular activities, benchmarks, or quality of practice assessment rubrics. The user designates, annotates, and certifies specific event clips as representative evidence associated with a target practice. Marked-up, performance evidence can then be accessed and viewed by either a single individual or across multiple users using the “view my clips tool.” The view my clips tool provides users with the capability to examine closely the performance of a single individual across multiple events, or multiple individuals across single events.

A plurality of different GUIs may be presented to a registered user (and others, including administrators of the VAT system 100). To provide a context for FIG. 3, the following summary is presented. In general, a user accessing a web-site associated with the VAT system 100 is presented with a GUI that enables a user to login as a registered user or subscribe as a new register. Such a login for a registered user may include a provision for entering a password or other manner of authenticating the user access to the VAT system. If accessing the web-site as a new user (un-registered), once completing the entry of requested information in a new registrant screen (not shown) or completing a printed form and sending to administrators of the VAT system, the user is registered and allowed to access the web-site with a username and password. Such registration and login methods and associated GUIs are well-known to those having ordinary skill in the art, and hence illustrations of the same are omitted for brevity.

Upon successful entry (login) into the VAT system 100, a GUI may be presented such as GUI 302 shown in FIG. 3. As is true with one or more of the GUIs presented herein, it can be appreciated that the GUIs may be displayed in some embodiments in association with a web browser interface (e.g., Explorer, with tool bars and other features), which is omitted from the figures except where helpful to understanding the features of the given interface. GUI 302 comprises selectable category icons, including home 304, video tools 306, my VAT 307, tutorial 308, and about VAT 310 icons. Tutorial icon 308 and VAT icon 310 provide, when selected, additional information about VAT system features and how to maneuver within the various GUIs presented by the VAT system 100. As the presentation of tutorial information and guidance information to assist in navigating a web-site are well-known topics to one having ordinary skill in the art, further discussion of the same is omitted for brevity.

Selection of any one of icons prompts the display of one or more drop-down menus (or in some embodiments, other selection formats) that provide further selectable choices or information pertaining to the selected icon, or in some embodiments, provides another GUI. For instance, responsive to a user selecting the video tools icon 306, a drop down menu 312 is presented in the GUI 302 that provides options including, without limitation, live observation 314 and create video clips 316. Selecting one of these options results in a second drop-down menu 318 that provides further options. In some embodiments, the second drop-down menu 318 may be prompted responsive initially to selection of video tools icon 306. The drop-down menu 318 comprises options including, without limitation, refine clips 320, view clips 322, and collaborative reflection 324, all of which are explained further below.

The live observation option 314, when selected by a user, presents an option for a scheduling GUI (not shown) that enables a user to schedule a live event. That is, the live observation tools of the VAT system 100 enable a user to schedule, conduct, and manage all live events. For instance, users are able to remotely observe an event (e.g., classroom instruction) from anywhere (e.g., office, home, etc.) with Internet access capabilities, through the evidence capture device 104 installed in the setting the user wishes to observe. Such a scheduling GUI comprises a pre-configured request form (not shown), provided via a VAT system web-site, with entries that can be populated by the user. In one embodiment, such a request form is automatically associated with a filename (although in some embodiments, a filename may be designated by the user). The entries may be populated with information such as a description of the file, subject, topic, grade level, start date and time, ending date and time, among other information. Once a user completes the request form, the user can submit (through selection of submit icons or the like) the request form, which is received by an administrator that has authority to approve the event. Approval or denial can be communicated from the administrator in a variety of ways. One mechanism implemented via the VAT system 100 is through a confirmation email sent by the administrator to the user.

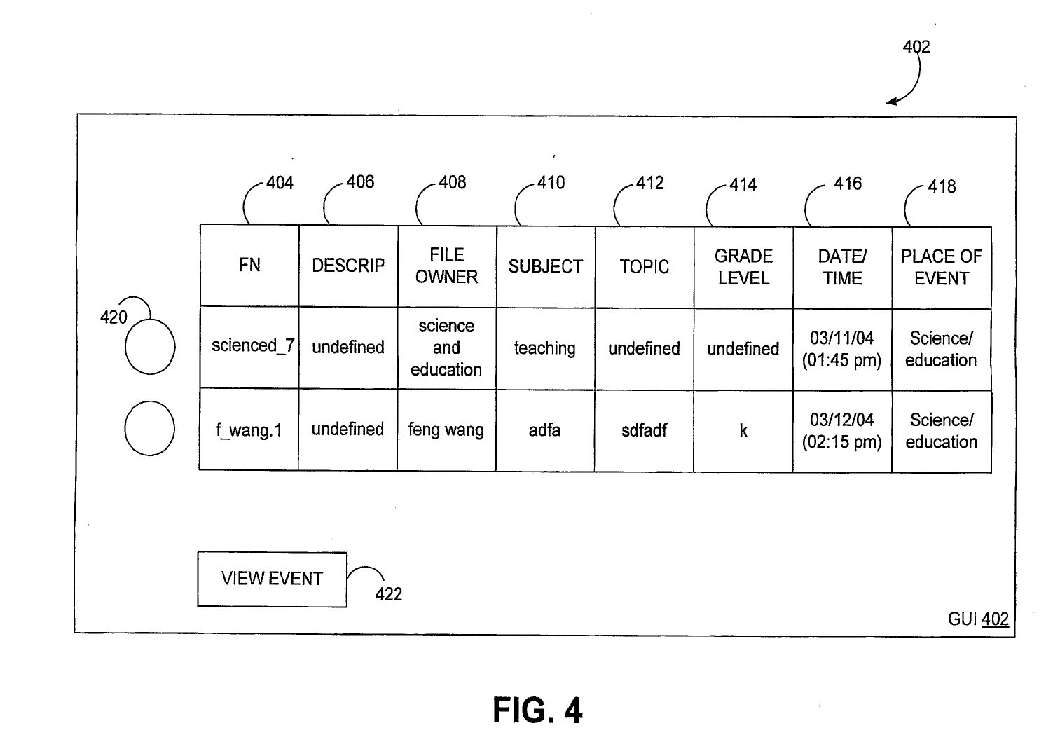

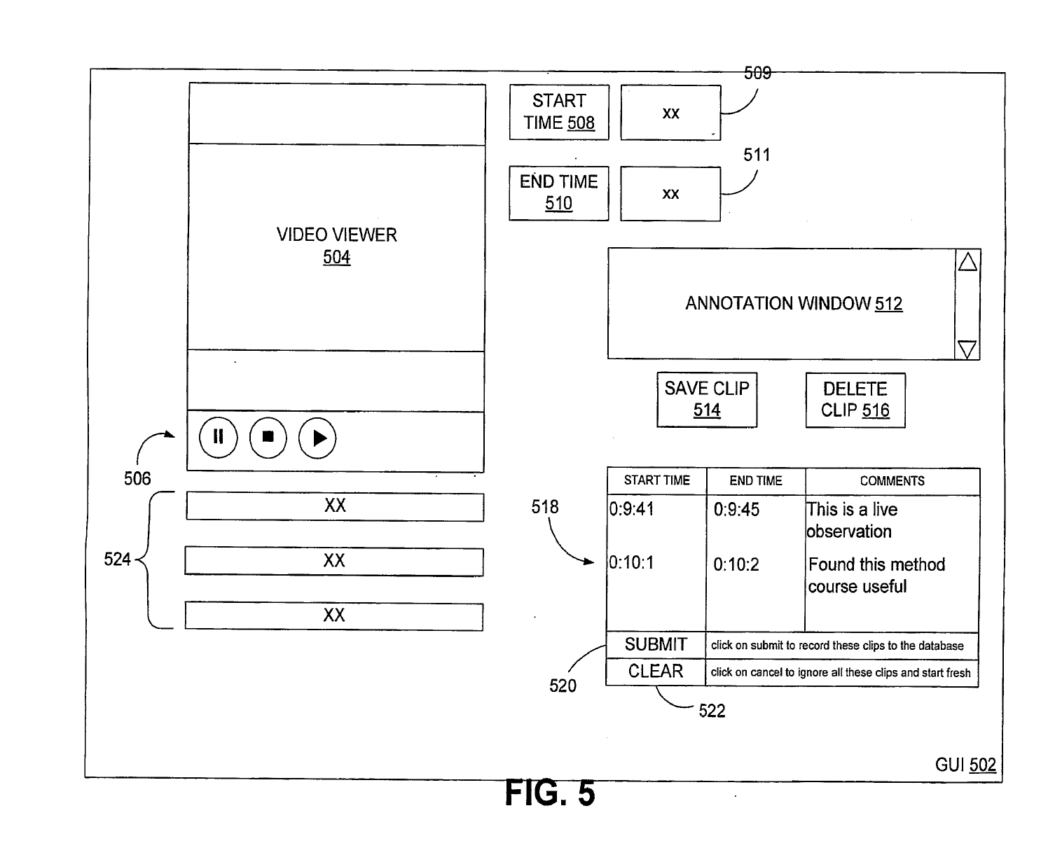

Additionally, information about the approved event is presented in a live event GUI 402, an exemplary one of which is shown in FIG. 4. In one embodiment, the live event GUI 402 can be presented as an option (e.g., a drop down menu) responsive to selecting the live observation icon 314. The live event GUI 402 may comprise information corresponding to one or more scheduled events for one or more different locations and times. A similar GUI, referred to as a manage live event GUI (not shown) may be presented through selection of a drop down menu item responsive to selection of the live observation icon 314. The manage live event icon enables users to view live events to be scheduled, live events scheduled, as shown by live event GUI 402, and live events already completed. Information in these interfaces can be presented in entries that include some or all of the information provided in the request form, among other information. For instance, the entries shown in live event GUI 402 include filename 404, description of the file 406, file owner 408, subject 410, topic 412, grade level 414, starting and ending dates and times 416, and place of event 418. The user can choose one of the radio button icons 420 corresponding to the live event of interest, and select the view event icon 422 to prompt a view event GUI 502, an exemplary one of which is shown in FIG. 5.

The view event GUI 502 provides an interface in which the user can view live (e.g., real-time) video/audio of an event and mark or tag segments of the video that are of interest to the user, and which further provides the user the ability to provide comments for each segment while the video/audio is being viewed in real-time. That is, the view event GUI 502 provides users with tools to segment video data into smaller, more meaningful and manageable events. Such segments are also referred to herein as clips. In one embodiment, the view event GUI 502 comprises a video viewer 504 (also referred to herein as a video player) with control button icons 506 to pause, stop, and play, as well as provide other functionality depending on the given mode presented by the video viewer 504. The view event GUI 502 further comprises a start time button icon 508 (with a corresponding start time window 509 that displays the start time) and an end time button icon 510 (with a corresponding end time window 511 that displays the start time), an annotation window 512 to enter commentary about a given segment or frame, a save clip button icon 514, a delete clip button icon 516, a summary window 518, a submit button icon 520, a clear button icon 522, and a status information area 524. Note that the descriptive text within a particular window (e.g., “This is a live observation” in summary window 518) is for illustrative purposes, and not intended to be limiting. Further, “XX” is used in some windows of the illustrated interfaces to symbolically represent text.

Responsive to clicking the view event icon 422 (for a selected file via selection of the corresponding radio button icon 418) in the GUI 402 of FIG. 4, if the event has not yet started, a barker screen (not shown) is displayed that provides an indication of the time remaining (and/or other status information) before the event is scheduled to start. In some embodiments, the view event GUI 502 is displayed when the event has not started, with the status information provided in the status information area 524, in the video viewer 504, or elsewhere in some embodiments. If the event has started or is starting, the view event GUI 502 is displayed with the event observable (with accompanying audio) in the video viewer 504. Below the video viewer 504, the status information area 524 provides information such as start time, scheduled end time, the time when the user began viewing the event, among other status information. Segments of the video presented in the video viewer can be identified (e.g., marked or tagged) by the user selecting the start time button icon 508, or in some implementations, by selecting the start time button icon 508 followed by the end time button icon 510, while the live video is played (or paused, as desired by the user). The view event GUI 502 also enables a user to enter comments in the annotation window 512 to assist in reminding the user as to the significance of the marked or tagged segment.

By clicking the save clip button icon 514, a user can save the clip information or metadata (e.g., start clip time, end clip time, comments) to the VAT system 100, which is reflected in the corresponding section of the summary window 518 located beneath the save and delete clip button icons 512 and 514, respectively. Additionally, the user can delete such information by selecting the delete clip button icon 516. The view event GUI 502 also provides the user with the ability to finalize the clip creation process. For instance, the user can select the submit button icon 520 to save metadata corresponding to the marked clips and proceed to the create clips interfaces (explained below) of the VAT system 100, or delete the same by selecting the clear button icon 522. In some embodiments, assessment of the video based on lenses can be implemented (and hence the clip creation process completed) through the view event GUI 502.

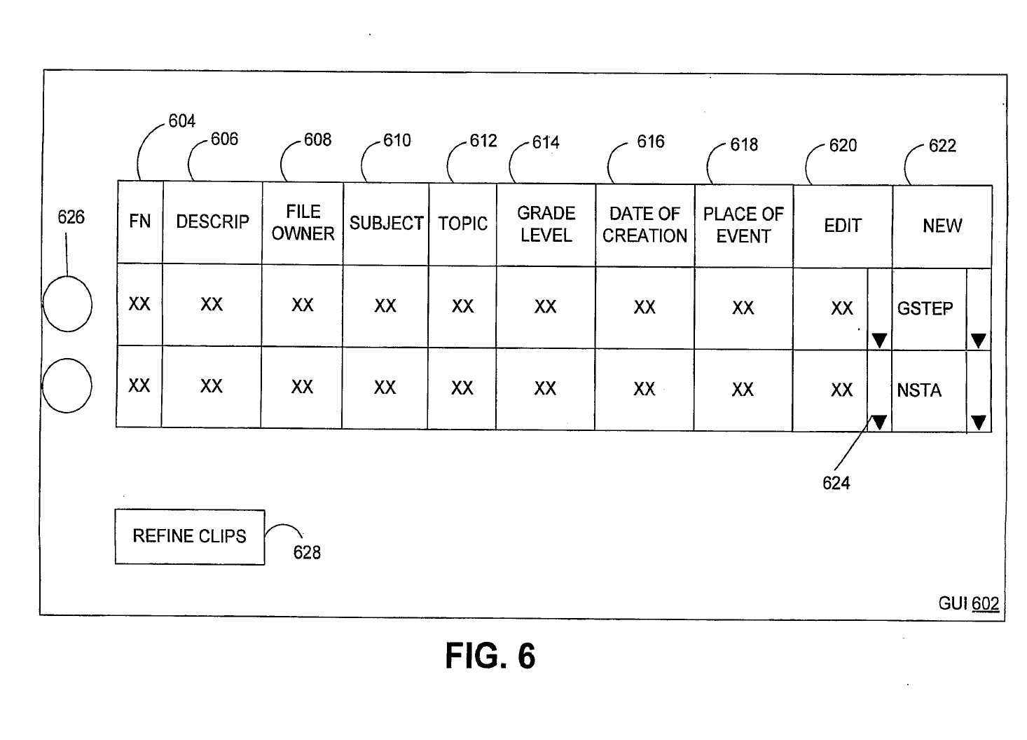

Returning attention to FIG. 3, the GUI 302 provides the create video clips option 316. A user selecting the create video clips option 316 has likely reached a stage whereby the teaching or mentoring practice has already been captured and uploaded into the system (and possibly tagged and/or annotated to some extent during live viewing, as in the view event GUI 502 of FIG. 5). Thus, responsive to selecting the refine clips option 320, the VAT system 100 provides an exemplary file list GUI 602 as shown in FIG. 6. The file list GUI 602 is similar in format to that shown in FIG. 4, and includes entries corresponding to filename 604, description of the file 606, file owner 608, subject 610, topic 612, grade level 614, date of creation of the video 616, and place of event 618. The GUI 602 also includes additional entries that are selected based on whether segments have been coded or not. Coding the segments includes associating standards-based assessment tools or lenses with one or more segments. The lenses may be industry-accepted practices or procedures, or proprietary or specific to a given organization that implements such practices or procedures company-wide. If segments have been coded already with a particular lens, the user may apply a different lens by selecting the file of interest using the radio button icon 626, manipulating the scroll icon 624 in edit option 620 to apply a different lens, and selecting the refine clips button icon 628. If segments have not been coded, the user may apply a lens by selecting the file of interest using the radio button icon 626, manipulating a scroll icon 624 (or like-functioning tool) in the new option 622 to apply a desired lens to the segment, and selecting the refine clips button icon 628.

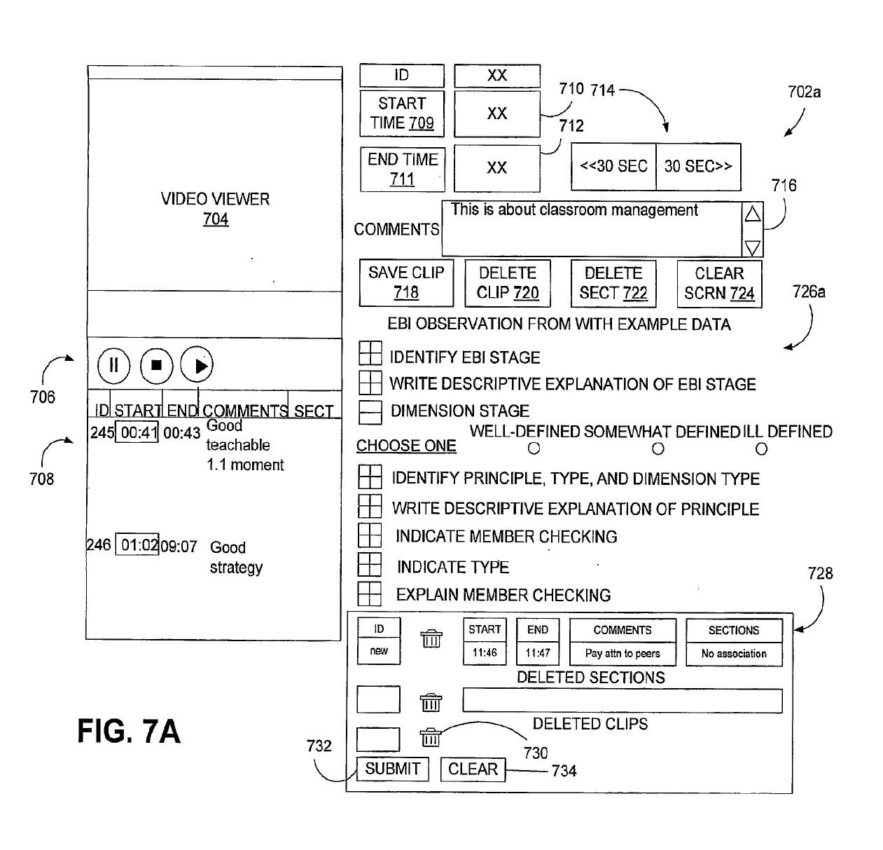

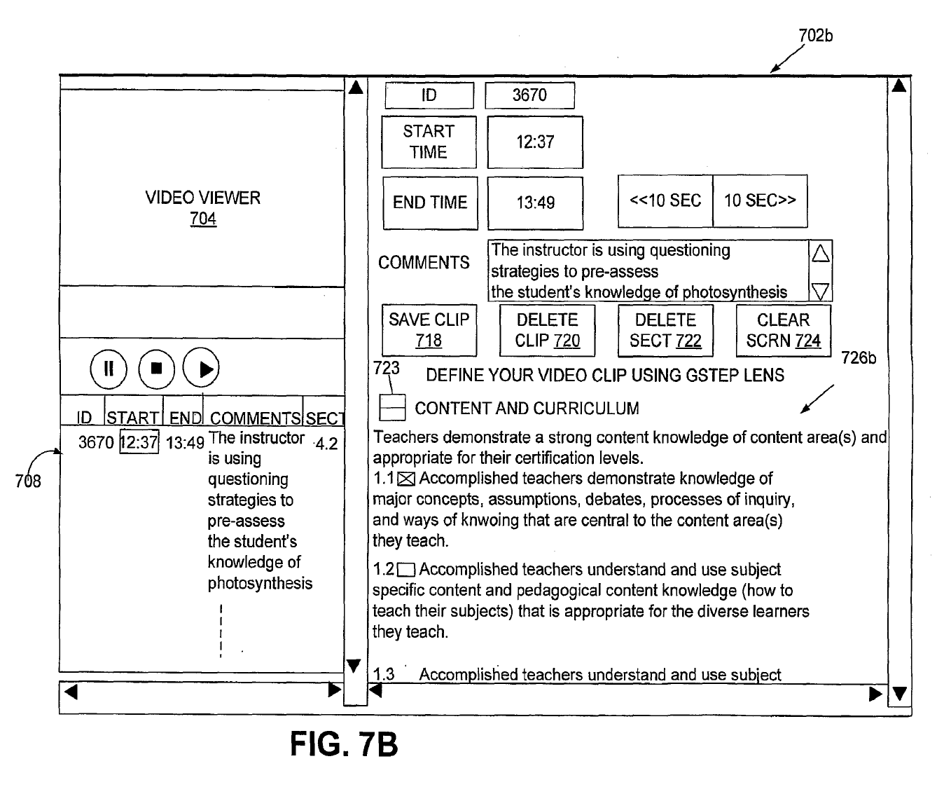

Responsive to selecting the refine clips button icon 628, the refine clips GUI 702a is provided as shown in FIG. 7A. The refine clips GUI 702a, in general, enables user control of the video content and data for pre-recorded video. The refine clips GUI 702 provides control buttons (e.g., start and stop time) that enable the user to further segment video content to create and refine multiple clips (chunks of video) by identifying start and end points of specific interest. Users can then annotate segmented events using a text-box form or other mechanisms by associating text-based descriptors with the different time-stamped clips or segments. For instance, users describe the event, assess practices or learning, or even assess implementation of strategies. These annotations are stored as metadata and associated with a specific segment of the video content.

In particular, the refine clips GUI 702a comprises a video viewer 704, video control button icons 706 (enabling start, stop, or pause of the video displayed in the video viewer 704), and a clip ID window 708 that identifies the saved clips. “Section” shown in clip ID window 708 is a label intended to show information representing the association(s) a VAT user made between a video clip and the descriptors represented in the lens (descriptors on the lens would be measures of practice that include a sentence stating the expected outcome and a scale of measurement—for example). In the sections area appears the output (e.g., domain/attribute/scale 4.1.3 . . . ) from a user clicking on descriptors/measures within the lens area (described below). The user can save clips, or tag, annotate, and code clips while viewing the clips by selecting the start button icon 709, or the start and end and end button icons 709 and 711 (the values of which are reflected in the start and time windows 710 and 712, respectively). That is, the user can segment the video file into clips by selecting the start and end button icons 709 and 711, while the video is played or paused. Fast reverse and fast forward button icons 714 are also presented in the refine clips GUI 702. The two button icons 714 (each entitled “<<30 seconds” and “30 seconds>>”), when selected by the user, enable the user to rewind or fast forward the video in 30 second increments, hence facilitating review. Though shown using 30 second increments, the interval is configurable by the user, and hence other values may be implemented. The refine clips GUI 702a also comprises an annotation window 716 for enabling the user to provide comment for a selected segment while the video is played or paused.

A lens area 726a is included, which the user can select to provide a standards-based assessment of the particular clip or clips identified by the user. Using the metaphor of a camera lens, the refine clips GUI 702a progressively guides users in systematically analyzing video segments, simultaneously generating and associating metadata specific to the frame or “lens” through which practices are examined. The lens essentially defines the frame for analysis. Lenses can be selected (e.g., via GUI 602) from among existing frames or frameworks (e.g., National Educational Technology Standards), or developed specifically for a given analysis. In teacher development, a lens might be used to look specifically at the teaching standards established by national organizations (e.g., Science Literacy Standards). Once a lens has been selected, filters are used to highlight or amplify specific aspects within the frame. In science, a filter might amplify specific attributes of teaching practice.

Gradients, usually in the form of rubrics, are used to differentiate the filtered attributes in an effort to identify progressively precise evidence of teaching practices. Hence, lenses, filters and gradients, applied directly to a specific video clip, enables simultaneous refinements in analysis as well as generation of associated explanations. Each video clip can have a theoretically unlimited number and type of associated metadata from any number of users, thus providing essential tags for subsequent use as flexible learning objects. Thus, the user selects one or more of the icons provided in the lens area 726 to implement a standards-based assessment of the video.

One example of how a user can assess the video using a lens is shown in FIG. 7B, which shows one embodiment of a refine clips GUI 702b using a GSTEP lens (GSTEP corresponding to a well-known education methodology). The clip identification (ID#367) is shown in the clip ID window 708, which includes the start and end time of the clip and comments provided by the user that describes his or her observations about the clip. The clip ID, start and end times, and comments are also reflected in other areas or windows of the GUI 702b. The lens area 726b illustrates that the user has implemented a GSTEP lens, and responsive to selecting a content and curriculum icon 723, the user is guided through selection of one or more options (e.g., option 1.1) that supplement his or her assessment based on the GSTEP lens or methodology, providing a standards-based assessment of the evidence (the video clip identified as #3670).

Returning to FIG. 7A, several button icons corresponding to save clip 718, delete clip 720, delete section 722, and clear screen 724 are also presented in the refine clips GUI 702. The save clip button icon 718, when selected, saves metadata corresponding to the clip, such as comments, markups, and lens information, to the VAT system 100. The delete clip button icon 720 deletes such information and enables the user to redo the process. The clear screen button icon 724, when selected, allows the user to clear the comments corresponding to a clip from the summary window 708 and annotation window 716 while retaining the clip. The summary area 728 provides a summary of the clips, related comments, and framework items (lens information) that are saved. The user can delete any clip from the summary icon 728 by highlighting the information in the summary area 728 and clicking the trash icon 730. Also included in the refine clips GUI 702a are submit and clear button icons 732 and 734, respectively. The user can select the submit button icon 732 to finalize the clip creation process, or the information in the summary area 728 can be cleared by selecting the clear button icon 734.

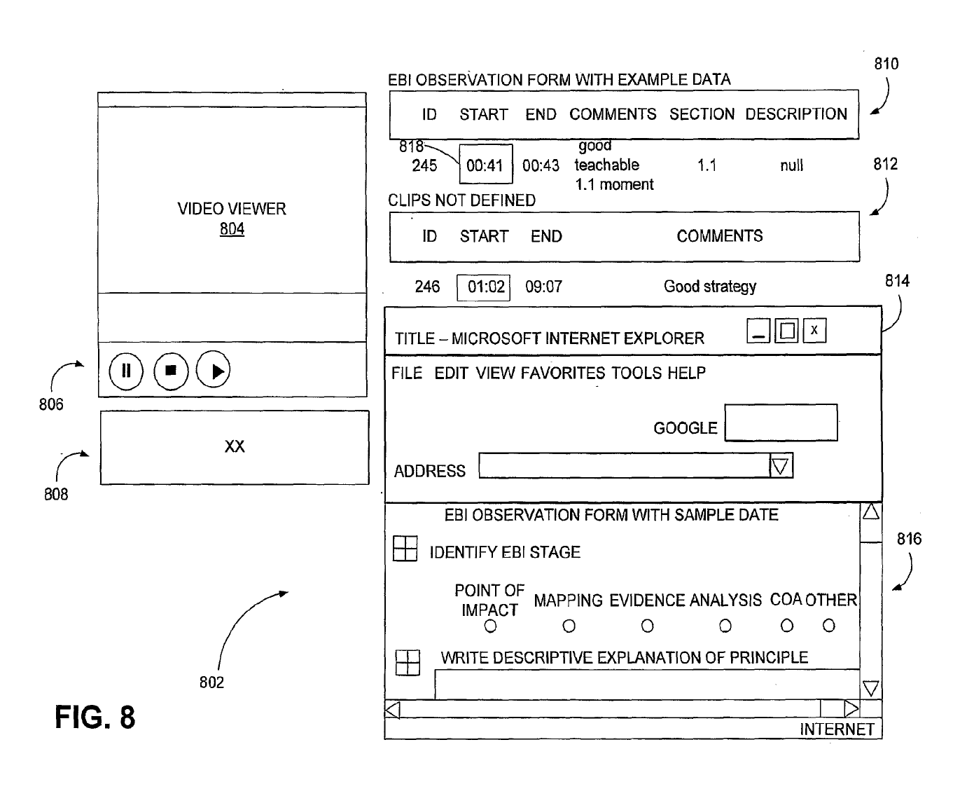

Users can retrieve, view and modify individual or multiple clips that they (or others) create in association with the VAT system 100. For instance, referring to the GUI 302 shown in FIG. 3, the view clips option 322 can be selected to access files and clips from the user or other users. Upon selecting the view clips option 322, the view clips GUI 802 is presented, as shown in FIG. 8. The view clips GUI 802 comprises a video viewer 804 and controls 806, similar to those shown in previous GUIs, as well as an information area 806 pertaining to the file corresponding to the displayed video. Information area 806 includes, without limitation, information pertinent to the video, such as the teacher's name, observer's name, class name, date of the event; and place of the event. The view clips GUI 802 also comprises a coded clips area 810, clips not defined area 812, and a browser window 814, which includes a lens area 816. The view clips GUI 802, when selected, activates the embedded video viewer 804 and the information area 808, the latter which provides a table display (or other format) of metadata associated with a selected file. By clicking a start button icon 818, the user can identify system-generated time-stamps for start/end of clips. Annotations associated with each clip as well as metadata assigned by the user(s) are automatically generated and displayed in coded clips area 810 and clips not defined area 812. Thus, the user can examine how they analyzed a segment, and such features provide an opportunity to see how others analyzed, rated, or associated the event.

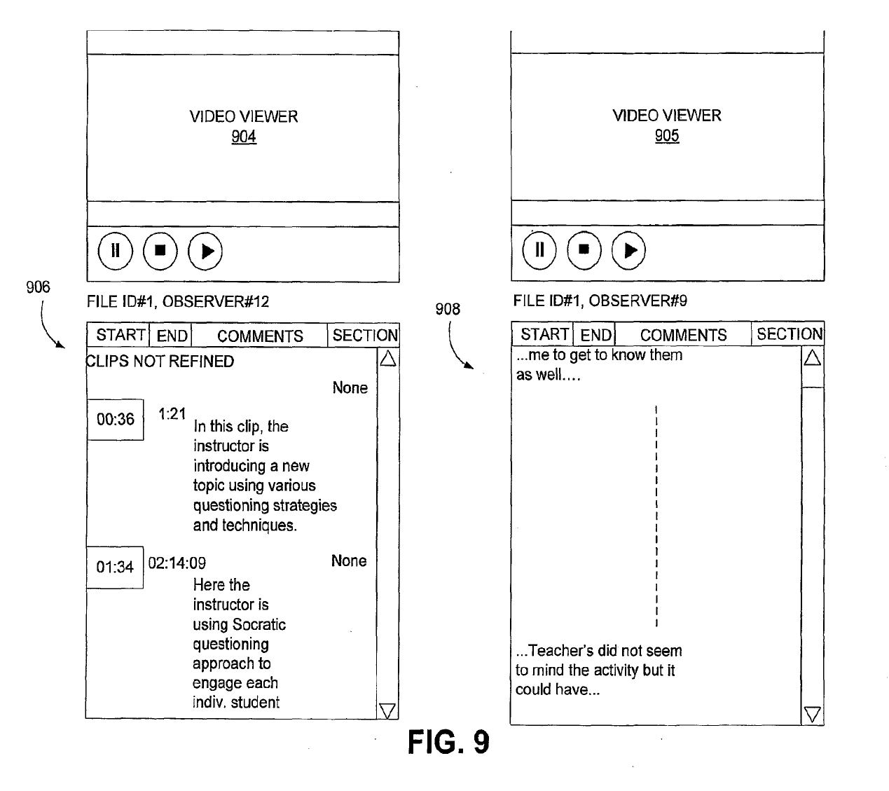

FIG. 9 illustrates a view multiple clips GUI 902 prompted from selection of the collaborative reflection icon 324 in the GUI 302 of FIG. 3. The view multiple clips GUI 902 includes two or more video viewers 904 and 905 with corresponding controls, each of which are similar to that previously described. The view multiple clips GUI 902 also comprises comment windows 906 and 908 for respective video viewers 904 and 905. The view multiple clips GUI 902 enables users to select two or more video files to display side-by-side in the browser window. The associated metadata provided in the respective comment windows 906 and 908 enables individual teachers to examine their own teaching events over time, compare their practices to others (experts, novices) using the same lenses, filters and gradients. Teachers can select one video focusing on their teaching practices and another focused on student activity to examine interplay according to the user's goals.

Referring again to FIG. 3, another option selectable by the user is the my VAT icon 307. Through selection of the my VAT icon 307, a user can manage his or her account and file(s). In one embodiment, the VAT system 100 is configured to be a secure system, with all rights and ownership of video and other evidence residing in the creator. That is, given the sensitivity and potential concerns and liabilities involved in collecting and sharing of the video content as learning objects, precautions are taken to ensure security and management of content the data. VAT content is controlled by the individual who generated the source content (typically the teacher whose practices have been captured), who “own” and control access to and use of their video clips and associated metadata, and subsequent learning objects.

Each content owner can grant or revoke others' rights to access, analyze, or view video content or metadata associated with their individual clips. Through the my VAT icon 307, the user can display one or more interfaces that enable the user to grant or revoke rights to access files. In one embodiment, an interface may comprise lists of people, one list comprising names of people with access, and another list comprising names of people without access. Using revoke and grant button icons (not shown) or other mechanisms, such as drag and drop, the user can alter the lists to revoke or grant access. Other interfaces are available through the my VAT icon, including interfaces to manage files (e.g., modify information such as file description, subject, topic, etc.) as well as interfaces to enable communication (e.g., electronic mail, or email) to the various members of the VAT system 100.

VAT functionality (or hereinafter, simply referred to also as VAT) may be implemented across a range of applications in multiple sectors, education (training teachers), military (pilot assessment), medicine (learn surgical procedures), and industry (train the trainers). Preservice teachers in Science Education, for example, may utilize VAT in methods courses, early field experiences, and during student teaching. Military instructors may integrate VAT methods to promote pilot training and feedback. VAT may also be incorporated into in-service professional development programs, to provide learning opportunities for industry trainers and improve their instructional strategies. In the following sections, several VAT applications are described. These are indicative of the current research and development that has been funded and does not reflect the full range of VAT applications.

VAT enables users to define, unequivocally, what specific enactments of practice and performance look like—that is, they make key practices visible and explicit. It enables extended performance sessions to be chunked into events, then refined according to the focus established by specific lenses, filters and gradients. For example, mathematics classroom teaching practices—expert or novice—can be chunked and refined using National Council for Teaching of Mathematics (NCTM) standards. These standards are operationalized using filters that amplify specific aspects of NCTM standards. Fine-grained embodiments can then be further refined using gradients, often in the form of rubrics, to differentiate qualitatively the manner in which the embodiments are manifested. The captured practices can also be re-analyzed using either the same tools or an entirely different set of lenses, filters, and gradients. Thus, VAT's capacity to specify and codify practices according to different standards enables theoretically unlimited learning object definitions and applications using the same captured practice.

Enactments of practice—exemplars, typical, or experimental—provide the raw materials from which objects can be defined. This is especially important in making evidence of practice or craft explicit. It is often difficult, for example, to visualize subtleties in a method based on descriptions or to comprehend the role of context using isolated, disembodied example alone. The ability to generate, use, and analyze concrete practices, from entire events to very specific instances, provides extraordinary flexibility for learning object definition and use.

VAT may be used to capture, then codify and mark-up as learning objects, key attributes of standards-based practices. Concrete referents, codified using lenses, filters and gradients, can provide shared standards through which elements of captured practices can be identified to illustrate and analyze different levels and degrees of proficiency.

The procedures used to observe and evaluate surgical practices have come under considerable scrutiny. Often, observations yield low quality feedback, and thus rarely improve practices. In many cases, those who evaluate surgical practices often lack communication skills to convey critical feedback; rather than focusing on what needs to be learned and or what is lacking in practice, observations tend to focus on right or wrong. Codified embodiments of novice-through-expert practices can support professionals to identify such practices during their observations, as well as to guide practitioners to improve or replicate desired practices.

In one ongoing project to improve field-based support for student teachers, the faculty supervisor is working closely with mentors. Cooperating teachers, those who take on a student teacher in the local school, act as mentor and confidant. During student teaching the novice is immersed in a real environment for a lengthy period of time relying on the daily feedback of their mentor. The faculty supervisor may capture video of mentor-student teacher sessions. Using VAT for collaborative analysis, the faculty supervisor can point out a myriad of instances where the mentor is relying less on effective mentoring strategies and more on anecdotal stories about how things work in the classroom. Clearly, this can have a negative impact on the student teacher's performance in the classroom, which may be evident from analyzing video of teaching. Applying a mentoring strategy lens, the faculty supervisor and mentor can highlight specific instances where mentoring strategies can be improved. Working from pre-set action plans, the mentor can apply new strategies, analyze the video to see the difference in these enactments, and watch the outcomes become evident in the student teacher's practices the next class.

VAT-generated objects can be used as evidence to support a range of assessment goals ranging from formative assessments of individual improvement to summative evaluations of teaching performance, from identifying and remediating specific deficiencies to replicating effective methods, and from open assessments of possible areas for improvement to documenting specific skills required to certify competence or proficiency. It is preferred, therefore, to establish both a focus for, and methodology of, teacher assessment.

The Georgia Teacher Success Model (GTSM) initiative, funded by the Georgia Department of Education, focuses in part on practical and professional knowledge and skills considered important for all teachers. For instance, one model may feature six (6) lenses (e.g., Planning and Instruction) which amplify specific aspects of teaching practice to be assessed, each of which has multiple associated indicators (filters) that further specify the focus of assessment (e.g., Understand and Use Variety of Resources). Each indicator may be assessed according to specific rubrics (gradients) that characterize differences in teaching practice per the GTSM continuum. Thus in GTSM, teaching objects can be assessed in accordance with established parameters and rubrics that have been validated as typifying basic, advanced, accomplished, or exemplary teaching practice.

Once embodiments of practices have been defined and marked-up, VAT's labeling and naming nomenclature enables the generation of objects as re-usable and sharable resources. Initial objects may be re-used to examine for possible strengths or shortcomings, seek specific instances of a target practice within a larger object (e.g., open-ended questions within a library of captured practices), or as baseline or intermediate evidence of one's own emergent practice. Exemplary practices—those coded positively according to specific standards and criteria—can also be accessed. Marked-up embodiments of expert practices can also be generated, enabling access to and sharing of very specific (and validated) examples of critical decisions and activities among users.

Interestingly, VAT may be ideally suited to determine which objects are worthy of sharing. VAT implementation can be used to validate (as well as to refute) presumptions about expert practices. In the aforementioned example involving sharing standards-based teaching evidence, it was disclosed that multiple examples of purportedly “expert” practices can be captured and analyzed. Upon closer examination of the enacted practices, however, many may not be assessed as exemplary. Therefore, a validation component may also be employed.

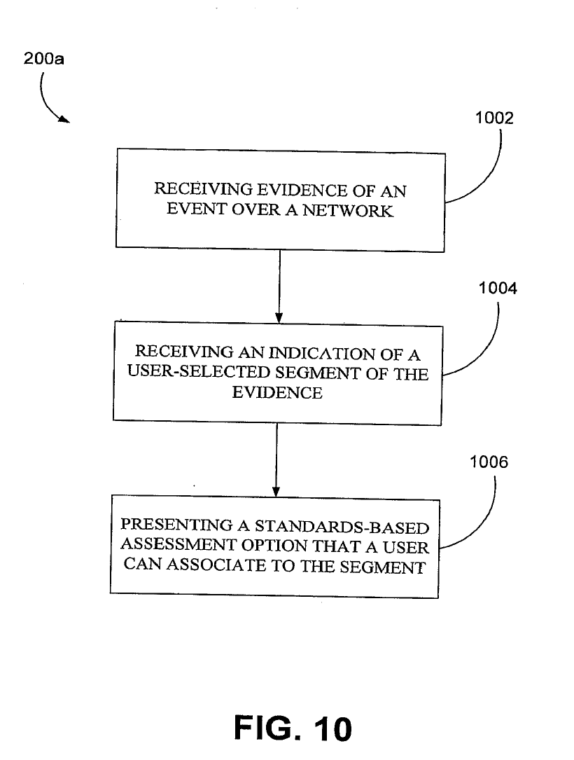

In view of the above-described embodiments of the VAT system 100, one VAT method implemented by the VAT software 200, referred to herein as method 200a and illustrated in FIG. 10, can be described generally as comprising the steps of receiving evidence of an event over a network (1002), receiving an indication of a user-selected segment of the evidence (1004), and presenting a standards-based assessment option that a user can associate to the segment (1006).

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

In addition, it can be understood by one having ordinary skill in the art, in the context of this disclosure, that although several different interfaces have been described and illustrated, other interface features may be employed to accomplish like-functionality for the VAT system 100, and hence such interfaces are intended as exemplary and not limiting.

It should be emphasized that the above-described embodiments of the present disclosure merely set forth for a clear understanding of the disclosed principles. Many variations and modifications may be made to the above-described embodiment(s). All such modifications and variations are intended to be included herein within the scope of this disclosure and protected by the following claims.

1. A method, comprising:
receiving evidence of an event over a network;
receiving an indication of a user-selected segment of the evidence; and
presenting a standards-based assessment option that a user can associate to the segment.

2. The method of claim 1, wherein receiving the evidence comprises receiving data corresponding to a live recording of the event, a pre-recorded version of the event, or a combination of both.

3. The method of claim 1, wherein receiving the evidence comprises receiving audio data corresponding to the event, video data corresponding to the event, monitored information corresponding to the event, or a combination of two or more of the video data, audio data, and monitored information.

4. The method of claim 1, wherein receiving the indication comprises receiving data corresponding to a start time and end time identifying the segment.

5. The method of claim 4, further comprising receiving data corresponding to a plurality of start times and end times identifying other segments of the evidence.

6. The method of claim 1, wherein presenting the standards-based assessment option comprises presenting a graphics user interface that provides a plurality of user-selectable standards-based assessment tools.

7. The method of claim 6, wherein the standards-based assessment tools are specific to a defined industry, specific to a defined company, or a combination of both.

8. The method of claim 1, further comprising presenting a graphics user interface that enables a user to enter comments about the segment during a real-time recording of the event, during a pre-recorded version of the event, or during both the real-time recording and pre-recorded version of the event.

9. The method of claim 1, wherein receiving the indication comprises receiving the indication during a real-time recording of the event, during a pre-recorded version of the event, or a combination of both.

10. The method of claim 1, wherein presenting the standards-based assessment option comprises presenting during a real-time recording of the event, during a pre-recorded version of the event, or a combination of both.

11. The method of claim 1, further comprising receiving a second indication corresponding to a user selecting the standards-based assessment option.

12. The method of claim 11, wherein receiving the second indication comprises receiving the second indication during a real-time recording of the event, a pre-recorded version of the event, or a combination of both.

13. A system, comprising:
a processor configured with logic to receive evidence of an event and an indication of a user-selected segment of the evidence, and present a standards-based assessment option that a user can associate to the segment.

14. The system of claim 13, wherein the processor is further configured with the logic to receive data corresponding to a live recording of the event, a pre-recorded version of the event, or a combination of both.

15. The system of claim 13, wherein the processor is further configured with the logic to receive audio data corresponding to the event, video data corresponding to the event, monitored information corresponding to the event, or a combination of two or more of the video data, audio data, and monitored information.

16. The system of claim 13, wherein the processor is further configured with the logic to receive data corresponding to a start time and end time identifying the segment.

17. The system of claim 16, wherein the processor is further configured with the logic to receive data corresponding to a plurality of start times and end times identifying other segments of the evidence.

18. The system of claim 13, wherein the processor is further configured with the logic to present a graphics user interface that provides a plurality of user-selectable standards-based assessment tools.

19. The system of claim 18, wherein the standards-based assessment tools are specific to a defined industry, specific to a defined company, or a combination of both.

20. The system of claim 13, wherein the processor is further configured with the logic to present a graphics user interface that enables a user to enter comments about the segment during a real-time recording of the event, during a pre-recorded version of the event, or during both the real-time recording and pre-recorded version of the event.

21. The system of claim 13, wherein the processor is further configured with the logic to receive the indication during a real-time recording of the event, during a pre-recorded version of the event, or a combination of both.

22. The system of claim 13, wherein the processor is further configured with the logic to present during a real-time recording of the event, during a pre-recorded version of the event, or a combination of both.

23. The system of claim 13, wherein the processor is further configured with the logic to receive a second indication corresponding to a user selecting the standards-based assessment option.

24. The system of claim 23, wherein the processor is further configured with the logic to receive the second indication during a real-time recording of the event, a pre-recorded version of the event, or a combination of both.

25. The system of claim 13, further comprising an IP camera configured to record the event.

26. The system of claim 25, further comprising a server configured to receive the evidence from the IP camera and provide the evidence to the logic.

27. The system of claim 25, wherein the IP camera is configured to provide the evidence to the logic.

28. The system of claim 13, wherein the logic comprises software stored on a computer-readable medium.

29. A system, comprising:
means for receiving evidence of an event;
means for receiving an indication of a user-selected segment of the evidence; and
means for presenting a standards-based assessment option that a user can associate to the segment.
